(19) United States
(12) Patent Application Publication
(10) Pub. No.: US 2021/0183363 A1
(43) Pub. Date: Jun. 17, 2021

(54) METHOD FOR OPERATING A HEARING SYSTEM AND HEARING SYSTEM

(71) Applicant: Sivantos Pte. Ltd., Singapore (SG)

(72) Inventor: Thomas Hempel, Erlangen (DE)

(21) Appl. No.: 17/120,519

(22) Filed: Dec. 14, 2020

(30) Foreign Application Priority Data
Dec. 13, 2019 (DE) 102019219567.9

(51) Int. Cl. G10L 15/00; H04R 25/00

(52) U.S. Cl. CPC G10L 15/005; H04R 25/554; H04R 2225/39; H04R 2225/43; H04R 2225/41

(57) ABSTRACT

A method for operating a hearing system having a hearing aid and a mobile device includes using at least one microphone of the hearing aid to record and convert sound signals into associated electrical microphone signals. The microphone signals are checked for the presence of speech components. Existing speech components are examined by using voice recognition and a voice profile thus recognized is assigned to a specific speaker. The mobile device is used to obtain additional information about the specific speaker that goes beyond personal information and the information is presented to a user of the hearing system. A hearing system for performing the method is also provided.

### CROSS-REFERENCE TO RELATED APPLICATION

This application claims the priority, under 35 U.S.C. § 119, of German Patent Application DE 10 2019 219 567, filed Dec. 13, 2019; the prior application is herewith incorporated by reference in its entirety.

### BACKGROUND OF THE INVENTION

### Field of the Invention

The invention relates to a method for operating a hearing system including a hearing aid and a mobile device. Furthermore, the invention relates to such a hearing system.

Hearing devices are generally used to reproduce sound signals to the auditory senses of the user of the hearing device. For that purpose, hearing devices include at least one output transducer, usually a speaker (also: “receiver”). Hearing devices in the form of so-called hearing aids, are used to supply sound signals to persons with reduced hearing ability. For that purpose, hearing aids regularly include at least one microphone, a signal processor for user-specific, frequency-dependent filtering, amplification and/or attenuation of sounds recorded by the microphone, and the aforementioned output transducer. Depending on the type of hearing loss, the output transducer can also be constructed as a bone conduction receiver or cochlear implant for mechanical or electrical stimulation of the auditory senses of the user. In addition to hearing aids, headphones, headsets, “hearables” and the like generally fall under the term “hearing device.”

It is known from European Patent EP 1 912 474 B1, corresponding to U.S. Pat. No. 8,194,900; European Patent Application EP 3 337 187 A1, corresponding to U.S. Pat. No. 10,547,956; German Patent Application DE 10 2008 040 002 A1; German Patent Application DE 10 2015 212 609 A1; International Publication WO 2013/189551 A1, corresponding to U.S. Pat. No. 9,602,935; and Japanese Patent Application JP 2000 125 397 A2, amongst others, that it is possible to (re)recognize speech components and, in particular, voices of one or even different speakers in the sound signals collected. In so doing, one goal is to “track” a speaker moving relative to a hearing device user, preferably with a “directional beam” of the microphones of the hearing device.

Furthermore, the voice recognition has, for example, the advantage that the signal processing of the signal processor can be adapted to the characteristics of the voice of the speaker.

### BRIEF SUMMARY OF THE INVENTION

It is accordingly an object of the invention to provide a method for operating a hearing system and a hearing system, which overcome the hereinafore-mentioned disadvantages of the heretofore-known methods and systems of this general type and which further improve the user comfort of a hearing device.

With the foregoing and other objects in view there is provided, in accordance with the invention, a method for operating a hearing system including a hearing aid and a mobile device, whereby according to the method:

sound signals are recorded and converted into associated electrical microphone signals by using at least one microphone of the hearing aid, the microphone signals are checked for the presence of speech components,

existing speech components are examined by using voice recognition and a voice profile recognized in this process is assigned to a specific speaker, and

additional information on the specific speaker, which goes beyond personal information, is obtained and presented to a user of the hearing system by using the mobile device, wherein it is checked whether there is language information on the specific speaker relating to a foreign language primarily spoken by the latter, and wherein a translation of the words spoken by the specific speaker is presented to the user if corresponding language information is assigned to the specific speaker.

The method according to the invention serves for the operation of a hearing system including (at least) one hearing aid (at least in the case of monaural provision of sound, or preferably two hearing aids in the case of binaural provision), as well as a mobile device including a hearing system. In accordance with the method, sound signals are recorded by using at least one microphone of the hearing aid and converted into associated electrical microphone signals. These microphone signals are then checked for the presence of speech components, and eventually for any speech components that are recognized, i.e. speech components that are present are examined by using voice recognition. A thereby recognized voice profile (which preferably is or will be assigned to a recognized speech component and which characterizes the corresponding speech component, in particular by distinguishing it from other speech components) is then assigned to a specific speaker. Through the use of the mobile device, additional information about the specific speaker is subsequently obtained and presented to a user of the hearing system (especially the “hearing aid user”).

In a preferred variant, a mobile device such as, for example, a cell phone, in particular a smartphone, a tablet, a “Smartwatch” or a comparable device is used. The additional information is preferably retrieved from a contact database, e.g. an “address book application,” which is installed locally on the mobile device, or which is stored online and managed by a corresponding application on the mobile device.

In an appropriate variant of the method, the mobile device (of the hearing system and thus of the hearing device wearer) maintains a conversation history of previous conversations with this specific speaker. The user of the hearing system (i.e. the hearing device wearer) is, in this case, given an up-to-date status of the conversation history as additional information when the specific speaker is recognized (in particular on the basis of the correspondingly assigned voice profile). In other words, the hearing device user will be informed about how often he/she has talked to the specific speaker—in particular within a limited, past time period, of preferably several days, in particular about a week—by using a display of the mobile device and/or acoustically through a speaker of the hearing aid. Optionally, if the last conversation lies further back in time than the time-limited period used, only the date of the last conversation is displayed. For example, it will be indicated that the hearing device user has talked to the specific speaker four times in the past week, or if the last conversation took place several weeks ago on May 29, 2019 (just as an example), the date of the last conversation will be displayed.

In a further appropriate variant of the method, appointment information linked to the specific speaker is given out—in addition or alternatively to the above additional information—as (possibly further) additional information.

Preferably, this information for this purpose is retrieved from a database managed by the mobile device, e.g. a calendar application or the like. For example, this appointment information contains a birthday (e.g., it is formulated in such a way that the specific speaker had a birthday a few days ago or has one in a few days), an upcoming meeting (e.g., an invitation agreed upon with the specific speaker), or the like.

In a further (additional or alternative) appropriate variant of the method, it is checked whether there is language information available for the specific speaker relating to a foreign language that he or she primarily (or exclusively) speaks. In other words, it is checked whether the specific speaker is a speaker of a foreign language. Preferably, this is also carried out by using additional information obtained through the mobile device, e.g. in the event that the contact database mentioned above contains a nationality or even the (only) spoken language of the speaker. In addition, or alternatively, the currently used language of the specific speaker is determined from the spoken words through speech recognition. In case the specific speaker speaks mainly or even only one foreign language (and/or is currently using this foreign language), the hearing device user is offered a translation of the words spoken (in particular currently) by the specific speaker. For example, for this purpose, dictation software preferably installed on the mobile device as well as translation software (installed or available online) will be used. The offering of the translation thereby optionally takes the form of a message on the above-mentioned display of the mobile device and/or by using an acoustic output through the speaker of the hearing aid—i.e. in the form of a simultaneous translation.

In an appropriate variant of the method, the hearing device user is asked to assign an unknown voice profile to a specific person if the voice recognition is unsuccessful. This is regularly the case when the hearing device user talks to a person, the voice profile of which has not yet been assigned to a contact from the above-mentioned contact database or who was previously unknown to the hearing device user. The request for assignment of the voice profile is made visually on the display of the mobile device and/or acoustically through the hearing aid. The input by the hearing device user is preferably made through the mobile device.

In a further appropriate variant of the method, the hearing device wearer is (also) asked to confirm the specific person when the voice profile is recognized. For example, the hearing device wearer is asked the question—optically and/or acoustically—whether the speaker is (actually) a determined person, specifically the person recognized on the basis of the speech component, in particular the voice profile. Within the scope of the method described here and below, it is advisable to determine a probability value for the speech component that the voice profile characterizing the speech component is known and assigned to a specific speaker. In this case, obtaining a confirmation is especially advantageous if the probability value is comparatively low due to, for example, loud additional or ambient noise.

In an advantageous variant of the method, the voice profile of the specific speaker is recorded in different acoustic environments during a learning phase that is carried out for the respective specific speaker. Preferably, when the voice profile is recognized for the first time and a specific speaker is assigned (in particular a contact is assigned to the voice profile), such a learning phase is started, which optionally extends over several conversations that are separated in time. In so doing, the probability is comparatively high that these conversations will take place in different environmental conditions, e.g. as a telephone call, a conversation in a room with two persons, outdoors with several other persons or similar. During these conversations, the voice profile is repeatedly revised—e.g. significant differences that could lead to a misidentification are smoothed by averaging or the like—so that a recognition can successfully be carried out with a high degree of probability in many different environmental situations. For example, a self-learning algorithm is used. Preferably, this learning phase is performed by the mobile device, preferably the smartphone, on which preferably a corresponding software application is installed.

In addition, when the voice profile and thus the specific speaker is recognized, the hearing device user is also shown a picture of the specific speaker, preferably stored in the contact database, together with a request for confirmation that this speaker is indeed the one in question.

In a further practical variant of the method—when the voice profile and thus also the specific speaker is recognized—processing of the signal in the hearing aid is recorded which is dependent on the specific speaker and in particular dependent on the voice profile. Optionally, frequencies which are known to be only weakly reproduced in the voice profile are picked up, and if necessary, known speech errors of the specific speaker are corrected or at least attenuated.

With the objects of the invention in view, there is concomitantly provided a hearing system, including the hearing aid described above, and the mobile device described above. The hearing system is set up—preferably by using a software application installed on the mobile device, which provides a corresponding control upon execution—to perform the above described method, preferably in an automatic manner, optionally in interaction with the hearing device user.

The hearing system thus has the same advantages as the method described above.

The conjunction “and/or” is, in particular, to be understood here and below in such a way that the characteristics linked by using this conjunction can be either common or can be developed as alternatives to each other.

Other features which are considered as characteristic for the invention are set forth in the appended claims.

Although the invention is illustrated and described herein as embodied in a method for operating a hearing system and a hearing system, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, plan view of a hearing system and a speaker; and

FIG. 2 is a flow chart of a method performed by the hearing system.

### DETAILED DESCRIPTION OF THE INVENTION

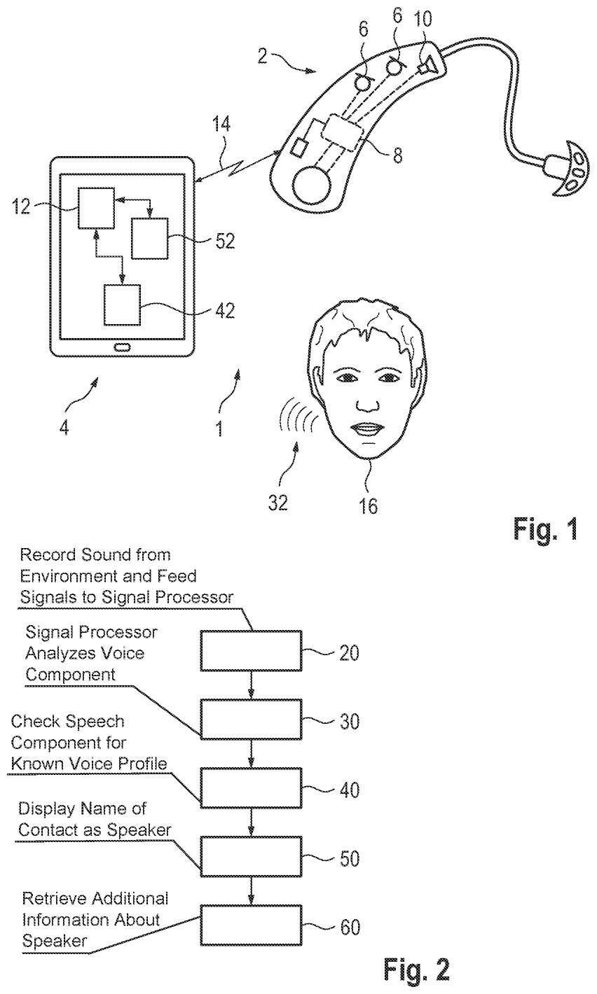

Referring now in detail to the figures of the drawings, in which parts corresponding to each other are always marked with the same reference signs, and first, particularly, to FIG. 1 thereof, there is seen a diagrammatically illustrated hearing system 1. The hearing system 1 includes a hearing aid, specifically a hearing aid to be worn behind the ear (referred to as “hearing device 2”), and a mobile device, in this case a Smartphone 4.

The hearing device 2 includes two microphones 6 for recording sound from the environment, a signal processor 8, which is set up for frequency-dependent filtering and amplification of sound signals (or: microphone signals) supplied by the microphones 6, as well as a speaker 10. When the hearing device 2 is operating as intended, the sound signals processed in the signal processor 8 are acoustically output by using the speaker 10.

The Smartphone 4 has a software application which, due to its installation on the Smartphone 4, forms a control for the hearing system 1 and is therefore referred to as “control app 12” in the following. Control app 12 is used to perform a method described in more detail below. For this purpose, the Smartphone 4 is set up to establish a bidirectional, wireless communication connection 14 (e.g. using the Bluetooth standard) with the hearing device 2 during intended operation. Within the scope of the above-mentioned method, the hearing system 1 is set up to recognize a specific speaker 16 by using acoustic analysis.

As shown in FIG. 2, in a first process step 20, sound from the environment of the hearing device 2 is recorded by using the microphones 6 of the hearing device 2 and fed to the signal processor 8 in the form of electrical sound signals.

In a subsequent process step 30, the signal processor 8 analyzes whether the sound signals contain a voice component 32 of a person. In the case that such a speech component 32 is contained, in a further process step 40 it is examined whether this speech component 32 contains a known voice profile. For this purpose, the voice profile determined for the speech component 32 is compared with the voice profiles assigned to known persons of the hearing device wearer who wears hearing device 2 and to whom the smartphone 4 belongs. For this purpose, the control app 12 accesses a contact database, which is managed by using an address book app 42 installed on the smartphone 4. In the contact database, any known voice profiles are assigned to specific contacts (i.e. individual persons) of the hearing device wearer.

If the currently determined voice profile is known and also assigned to a contact of the hearing device wearer, the control app 12 assesses this contact as the specific speaker 16. In a process step 50, the control app 12 displays the name of the contact as the current speaker 16 by accordingly controlling a display control 52 of the smartphone 4. If a picture is stored for this contact, the picture of the contact is also displayed. In addition, the system asks whether this contact is actually the current speaker 16.

If this is not the case, the control app 12 asks to which contact the currently determined, but previously unknown, voice profile can be assigned.

If the specific speaker 16 is confirmed, the control app 12 retrieves additional information about the specific speaker 16 from the address book app 42—or, for example, from another app—in a method step 60. In concrete terms, the app retrieves how often the hearing device wearer and the specific speaker 16 have spoken to each other in the last 10 days. This information is displayed to the hearing device wearer on their smartphone 4.

For the case in which the address book app shows that the hearing device user (only) speaks a foreign language, the hearing device user is offered the provision of a (e.g. machine, simultaneous) translation, for example, to display translated text on the smartphone display or to output it acoustically through the speaker 10 of hearing device 2.

The subject matter of the invention is not limited to the embodiment example described above. Rather, further embodiments of the invention can be derived from the above description by the person skilled in the art.

### REFERENCE CHARACTER LIST

1 Hearing system
2 Hearing device
4 Smartphone
6 Microphone
8 Signal processor
10 Loudspeaker
12 Control app
14 Communication link
16 Speaker
20 Process step
30 Process step
40 Process step
42 Address book app
50 Process step
52 Display control
60 Process step

1. A method for operating a hearing system including a hearing aid and a mobile device, the method comprising:
using at least one microphone of the hearing aid to record and convert sound signals into associated electrical microphone signals;
checking the microphone signals for a presence of speech components;
using voice recognition to examine existing speech components and assigning a voice profile recognized by the voice recognition to a specific speaker;
using the mobile device to obtain and present to a user of the hearing system additional information about the specific speaker going beyond personal information;
checking for language information about the specific speaker relating to a foreign language primarily spoken by the specific speaker; and
presenting a translation of words spoken by the specific speaker to the user upon corresponding language information being assigned to the specific speaker.

2. The method according to claim 1, which further comprises using the mobile device to keep a conversation history of already made conversations for the specific speaker, and providing the user of the hearing system with a current status of the conversation history as additional information, upon recognition of the specific speaker.

3. The method according to claim 1, which further comprises outputting appointment information linked to the specific speaker as additional information.

4. The method according to claim 3, which further comprises retrieving the appointment information from a database managed by using the mobile device.

5. The method according to claim 1, which further comprises, in an event of unsuccessful voice recognition, sending a request to the user for assignment to a specific person of an unknown voice profile contained in the voice components.

6. The method according to claim 1, which further comprises asking the user to confirm the specific person upon recognizing a voice profile.

7. The method according to claim 1, which further comprises, during a learning phase for the specific speaker, recording the voice profile of the specific speaker in different acoustic environments.

8. The method according to claim 1, which further comprises using the hearing aid to record signal processing being dependent on the specific speaker.

9. The method according to claim 8, wherein the signal processing is voice profile-dependent.

10. A hearing system, comprising a hearing aid and a mobile device configured to perform the method according to claim 1.
